(19) United States
(12) Patent Application Publication
(10) Pub. No.: US 2025/0247155 A1
(43) Pub. Date: Jul. 31, 2025

(54) OPTICAL COMPUTING DEVICE FOR ARTIFICIAL INTELLIGENCE ACCELERATORS AND METHOD OF OPERATING THE SAME

(71) Applicant: TAIWAN SEMICONDUCTOR MANUFACTURING COMPANY LTD., HSINCHU (TW)

(72) Inventors: SHINN-SHENG YU, HSINCHU (TW); YUTONG WU, HSINCHU CITY (TW)

(21) Appl. No.: 18/670,757

(22) Filed: May 22, 2024

Related U.S. Application Data
(60) Provisional application No. 63/627,015, filed on Jan. 30, 2024.

(51) Int. Cl. H04B 10/524; H04L 7/00

(52) U.S. Cl. CPC H04B 10/524; H04L 7/0075

(57) ABSTRACT

An optical circuit includes: a source pixel configured to generate a plurality of input optical pulses with a time interval; a modulator pixel optically coupled to the source pixel and configured to modulate the plurality of input optical pulses to generate a plurality of modulated optical pulses; a detector pixel optically coupled to the modulator pixel and configured to generate charges in response to the plurality of modulated optical pulses; and a controller configured to electrically control an intensity of each of the plurality of input optical pulses and modulation levels of the modulator pixel to perform a multiplication-accumulation operation.

### PRIORITY CLAIM AND CROSS-REFERENCE

This application claims the benefit of U.S. provisional application No. 63/627,015 filed Jan. 30, 2024, the disclosure of which is incorporated by reference herein in its entirety.

### BACKGROUND

Artificial intelligence (AI) is an emerging technique in recent years and has been becoming a powerful tool to simulate human intelligence by machines that are programmed to think and act like humans. AI has attracted lots of attention since its applicable scenarios are more prevalent than any other previous high technologies, and can be used in a variety of applications and industries. AI accelerators are hardware devices constructed by processors, memories and interface elements for efficient processing of AI workloads like neural networks.

### BRIEF DESCRIPTION OF THE DRAWINGS

Aspects of the present disclosure are best understood from the following detailed description when read with the accompanying figures. It should be noted that, in accordance with the standard practice in the industry, various structures are not drawn to scale. In fact, the dimensions of the various structures may be arbitrarily increased or reduced for clarity of discussion.

FIG. 1 illustrates a block diagram of a neural network, in accordance with some embodiments.

FIG. 2 illustrates a block diagram of an optical computing device for optical computing, in accordance with some comparative embodiments of the present disclosure.

FIGS. 3A and 3B illustrate block diagrams of spatial light multiplexers (SLMs), in accordance with some embodiments of the present disclosure.

FIG. 4A shows a diagram of an optical computing device, in accordance with some comparative embodiments of the present disclosure.

FIG. 4B shows a diagram of an optical computing device, in accordance with some comparative embodiments of the present disclosure.

FIG. 5A shows a diagram of an optical computing device, in accordance with some embodiments of the present disclosure.

FIG. 5B shows a diagram of an optical computing device, in accordance with some embodiments of the present disclosure.

FIG. 6 shows a diagram of an optical computing device, in accordance with some embodiments of the present disclosure.

FIGS. 7A and 7B show block diagrams of semiconductor optical computing devices, in accordance with some embodiments of the present disclosure.

FIG. 8 shows a schematic flow chart of a method of operating an optical computing device, in accordance with some embodiments of the present disclosure.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawings. Further, like reference numerals across different figures dictate similar features, and therefore a detailed explanation of the similar feature may be provided when such features are first introduced in the disclosure, and may not be subsequently repeated.

### DETAILED DESCRIPTION

The following disclosure provides many different embodiments, or examples, for implementing different features of the provided subject matter. Specific examples of elements and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper,” “on” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

As used herein, although the terms such as “first,” “second” and “third” describe various elements, components, regions, layers and/or sections, these elements, components, regions, layers and/or sections should not be limited by these terms. These terms may be only used to distinguish one element, component, region, layer or section from another. The terms such as “first,” “second” and “third” when used herein do not imply a sequence or order unless clearly indicated by the context.

The electronics industry has experienced an ever-increasing demand for smaller and faster electronic devices that are simultaneously able to support a greater number of increasingly complex and sophisticated functions. To meet these demands, there is a continuing trend in the integrated circuit (IC) industry to manufacture low-cost, high-performance, and low-power ICs. Efforts have been spent to achieve these goals largely by reducing IC dimensions (for example, minimum IC feature size), thereby improving device performance and lowering associated costs. However, when the approaches using the electronic engineering have approached their physical limits, the improvement may not be attained as fast as before.

One of the major issues shared by most of the existing electronic circuits is the ever-increasing power consumption used in computing-intensive applications, e.g., artificial intelligence, deep learning, and machine learning, which are required to performing high-volume data computation in a short period of time. Such computation framework is generally implemented to emulate a neural network, e.g., convolutional neural network (CNN), deep neural network (DNN), constructed by a plurality of computation units, referred to herein as multiply-accumulate (MAC) unit. The more MAC units the computing-intensive device can leverage, the faster or the more computation tasks it can be achieved. However, the highly increasing power consumption of the computing-intensive device formed of the MAC units would frustrate the application and popularity of the computing-intensive semiconductor devices.

In this regard, it is proposed in the current disclosure to implement optical computing in an optical/photonic device in place of the electronics-based MAC units, in which the input activations of a neural network are represented by a plurality of optical beams or pulses, the weights of the neural network are implemented by a filtering operation of one or more spatial light modulator (SLM), and the output activations of the neural network are represented by a plurality of photodetectors. The energy consumption of optical computing for performing the MAC operations is therefore greatly reduced. Further, the proposed optical MAC architecture adopts a time-multiplexing approach, in which the multiplication operation performed in a space-multiplexing manner in the existing MAC unit is replaced by a time-multiplexing manner, thereby greatly reducing the need of a large-size matrix of pixels for accommodating the input activations and the weights of an extremely large matrix. Therefore, the computing-intensive device can deal with a large neural network model of almost unlimited input lengths at a cost of an unnoticeable time delay. Further, the hardware framework for implementing such computing-intensive device can be compatible with the current manufacturing processes of photonic devices, thereby making the optics-based energy-saving MAC computation feasible.

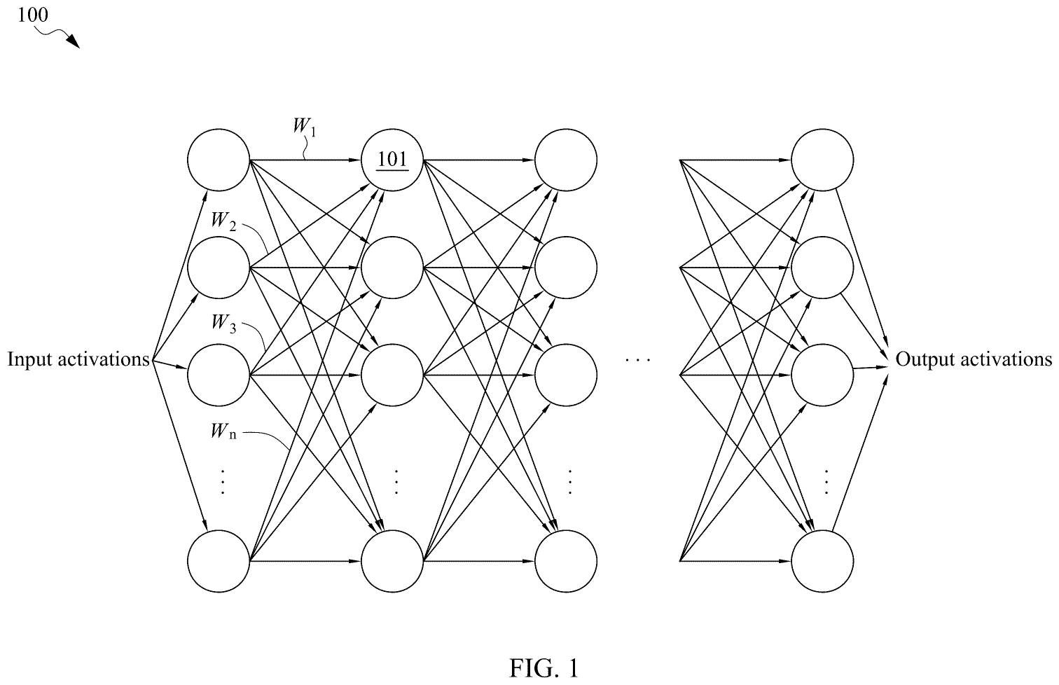

FIG. 1 illustrates a diagram of a neural network (model) 100, in accordance with some embodiments. As can be seen in FIG. 1, the neural network 100 is formed of a mesh-like interconnection structure by a plurality of inner layers (or hidden layers) of neurons. In FIG. 1, only one neuron 101 and the weights of input connections (w₁, w₂, w₃ . . . wₙ) are labeled for simplicity. The neurons in adjacent inner layers are connected with a connection having a weight, which is set according to the influence or effect that the preceding neuron in a preceding inner layer is to make on the subsequent neuron in the next inner layer. The output value or output activation of the preceding neuron is multiplied by the weight of its connection to the subsequent neuron to determine the particular stimulus that the preceding neuron is to exert on the subsequent neuron.

A neuron's total input stimulus includes the stimulation from all of its weighted input connections from the preceding neurons in the preceding inner layer. According to various configurations, if a neuron's total input stimulus exceeds some threshold, the neuron is triggered to provide an output or output activation following a linear or non-linear function based on its input stimulus. The abovementioned procedure repeats for each neuron of each inner layer until all of the neurons of the last inner layer provide the respective outputs.

Based on the characteristic of the neural network 100, the more connections between neurons, the more neurons per inner layer. Further, the more layers of neurons, the greater the artificial intelligence the neural network 100 is capable of emulating. As such, the neural network 100 for actual, real-world artificial intelligence applications are generally characterized by large numbers of neurons and large numbers of connections between neurons. Extremely large numbers of inputs and calculations (including both of neuron output functions and weighted connections) are therefore involved in operating the neural network 100.

The neural network 100 can be implemented with software or hardware. However, although the neural network 100 can be completely implemented in software as program codes that are executed on the cores of one or more general purpose central processing unit (CPU) or graphics processing unit (GPU) without constraints of wiring that would be otherwise encountered with hardware computing, the read/write activity between the CPU/GPU core(s) and system memory that is needed to perform the calculations, such as the MAC) operation, is extremely intensive. The overhead and energy associated with repeated data movement between the processing unit and the system memory to complete the tremendous amount of computations in a large-sized neural network 100 have not been entirely satisfactory in many aspects.

Referring to FIG. 1, the neural network 100 can perform a general MAC operation with a 1-by-K vector of input activations X, a K-by-N matrix of weights W, and a 1-by-N vector of output activations Y, wherein K and N are natural numbers. The MAC operation for a vector-matrix multiplication operation can therefore be expressed by a matrix representation as Equation (1) shown below.

$${X}_{1 \times K} {W}_{K \times N} = [ \begin{matrix}{X}_{1 , 1} & {X}_{1 , 2} & .. & {X}_{1 , k} & .. & {X}_{1 , K}\end{matrix} ] [ \begin{matrix}{W}_{1 , 1} & {W}_{1 , 2} & .. & {W}_{1 , n} & .. & {W}_{1 , N} \\ {W}_{2 , 1} & & & & & \\ .. & & & & & \\ {W}_{k , 1} & & & {W}_{k , n} & & \\ .. & & & & & \\ {W}_{K , 1} & & & & & {W}_{K , N}\end{matrix} ] = [ \begin{matrix}{X}_{1} \cdot {W}_{1} & {X}_{1} \cdot {W}_{2} & .. & {X}_{1} \cdot {W}_{n} & .. & {X}_{1} \cdot {W}_{N} ] = [ \begin{matrix}{Y}_{1 , 1} & {Y}_{1 , 2} & .. & {Y}_{1 , n} & .. & {Y}_{1 , N}\end{matrix} ] = {Y}_{1 \times N}\end{matrix} \qquad ( 1 )$$

In Equation (1), the vector of the input activations X is X=[x_{1,1}, x_{1,2}, . . . x_{1,k}, . . . x_{1,K}], the weights W is constructed by the matrix [w_{k,n}], and the output activations Y is constructed by the array of [Y_{1,1}, Y_{1,2}, . . . Y_{1,k}, . . . Y_{1,N}], wherein the index k represents the row index while the index n represents the column index.

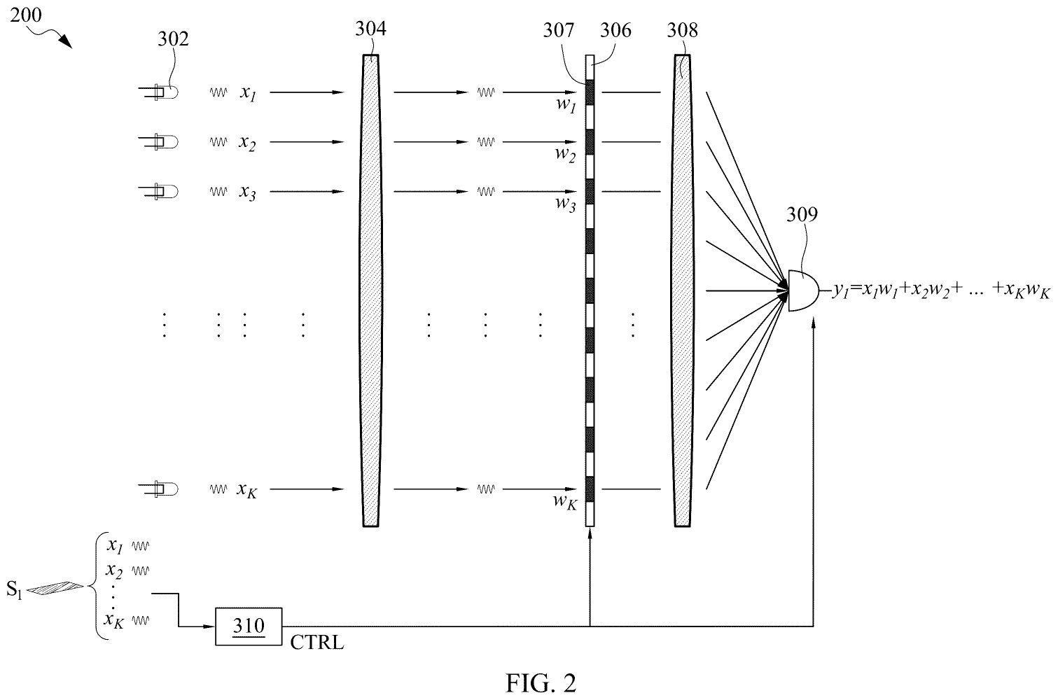

FIG. 2 illustrates a block diagram of an optical computing device 200 for optical computing, in accordance with some comparative embodiments of the present disclosure. The optical computing device 200 may be used to emulate the neural network 100 shown in FIG. 1. The optical computing device 200 is operated in the optical domain, and performs at least part of the MAC operations based on optical signal processing. For example, an algebraic accumulation operation of multiple input activations is performed by optically converging multiple optical signals that represent the input activations and outputting the converged or fanned-in optical signal that represents the output activation. Further, an algebraic multiplication operation of an input activation by a multiplier can be realized by optically directing an optical signal that represents the input activation to an optical element with a controllable modulation level in terms of a transmissivity or reflectivity value, and outputting the acquired output optical signal through the optical element as the output activation.

The optical computing device 200 includes an array of source pixels 302, a first optical element 304, a spatial light modulator (SLM) 306, a second optical element 308, a detector pixel 309 and a controller 310. The SLM 306 includes an array of modulator pixels 307 formed thereon. Although FIG. 2 only shows the aforementioned elements of the optical computing device 200, the present disclosure is not limited thereto. There may be more or fewer elements included in the optical computing device 200 in other embodiments.

According to some embodiments, the array of source pixels 302 is configured to receive values of the input activations of the neural network 100 and convert the values to intensities of an array of input optical beams/pulses. According to some embodiments, the source pixel 302 is formed of a liquid crystal display (LCD) with an array of light-emitting pixels. According to some embodiments, the source pixel 302 include a light-emitting diode (LED), e.g., an organic OLED, a mini OLED, a micro LED, or the like. According to some embodiments, the source pixel 302 is formed of vertical-cavity surface-emitting laser (VCSEL).

According to some embodiments, the first optical element 304 is configured to adjust the optical properties of the input optical beams/pulses transmitted by the source pixels 302 before they are incident on the corresponding modulator pixels 307 on the SLM 306. The first optical element 304 may include a lens, a mirror, a meta-lens, a combination thereof, or the like. According to some embodiments, the first optical element 304 includes a diffractive lens, a concave lens or a convex lens configured to direct the input optical beams/pulses and align the input optical beams/pulses with the corresponding modulator pixels 307 on the SLM 306.

The SLM 306 may include a liquid crystal display (LCD) panel including an array of modulator pixels 307. Each of the modulator pixels 307 may be a transmissive optical medium that has an adjustable transmissivity as the modulation level with respect to an optical beam/pulse incident thereon. The transmissive optical medium of the modulator pixel 307 allows the modulator pixel 307 to filter or modulate the input optical beams/pulses based on the modulation values in terms of transmissivity values according to the corresponding weights to realize the multiplication operation on the input optical beams/pulses. The modulation operation performed by the modulator pixels 307 is equivalent to the multiplication step of each input activation and its corresponding weight in the MAC operation.

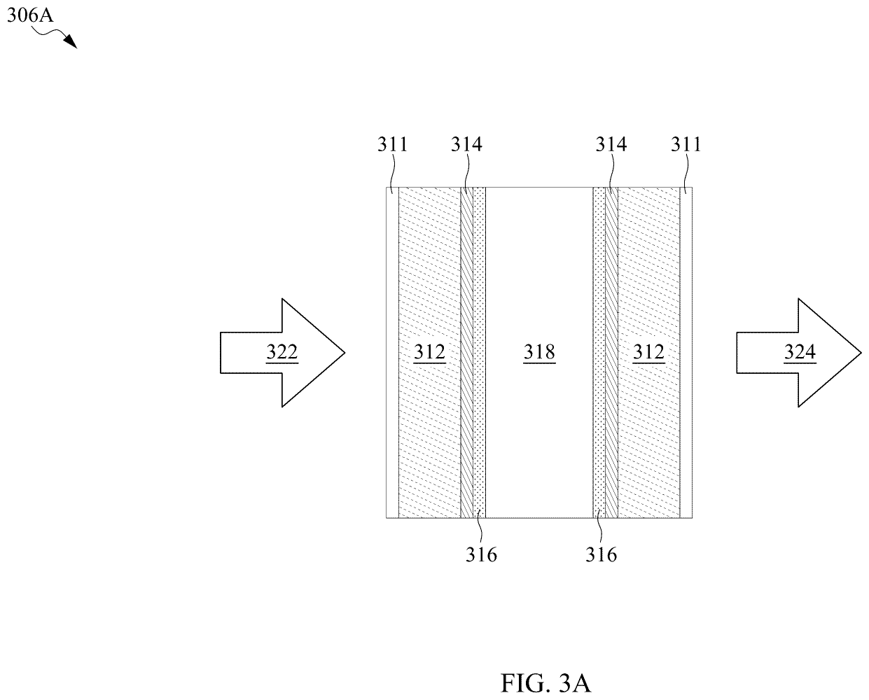

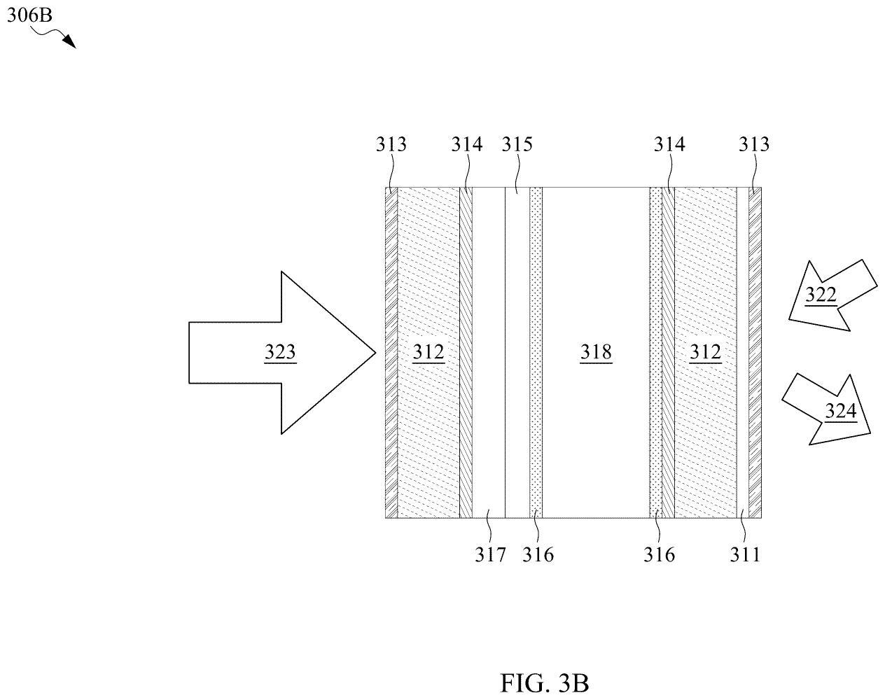

In some other embodiments, the SLM 306 alternatively adopts a reflective optical medium (not separately shown in FIG. 2, but illustrated in FIG. 3B and labeled as 306B) configured to reflect the incoming input optical beams/pulses and modulate the intensity of the input optical beams/pulses in terms of its reflectivity. The transmissive optical medium and the reflective optical medium are seen as various types of the SLM 306 that has one or more modulator pixels 307 configured to provide modulated optical beams/pulses based on its modulation levels in response to input optical beams/pulses based on their modulation values, either in terms of transmissivity or reflectivity, according to the corresponding weight factor, to exhibit the multiplication effect on the input optical beams/pulses. The modulation operation performed by the modulator pixels 307 is equivalent to the multiplication step of each input activation and its corresponding weight in the MAC operation.

According to some embodiments, the second optical element 308 is configured to adjust the optical properties of the modulated optical beams/pulses transmitted by the modulator pixels 307 before they are incident on the detector pixels 309 in a receiver of the optical computing device 200. The second optical element 308 may include a lens, a mirror, a meta-lens, a combination thereof, or the like. According to some embodiments, the second optical element 308 further includes a converging or concave optical element configured to direct or fan-in the modulated optical beams/pulses to the detector pixel 309 in the receiver.

According to some embodiments, the detector pixel 309 includes a photodetector or a photodiode configured to receive the modulated optical beams/pulses transmitted via the second optical element 308. According to some embodiments, the detector pixel 309 is configured to accumulate the modulated optical beams/pulses from each modulated pixel 307, and convert the accumulated photons of the optical beams/pulses into an electric current or charges. The value of the electric current or charges correspond to a value of the output activation of the neural network 100. The abovementioned light accumulation and charge conversion step is equivalent to the addition step in the MAC operation.

According to some embodiments, the controller 310 is configured to receive the parameters of the input activations and weights, and transmit control signals to the source pixels 302 and the modulator pixels 307 to determine the intensities of the optical beam/pulse of each source pixel 302 and the transmissivity of each of the modulator pixels 307. According to some embodiments, the controller 310 is configured to receive the electric current or charges generated by the detector pixel 309 and convert the same to the value of the output activation. According to some embodiments, the controller 310 includes a microcontroller, a field programmable gate array (FPGA), a general purpose center processing unit (CPU), an application-specific integrated circuit (ASIC), or the like.

Referring to FIG. 2, during operation, a training source S₁ is received or provided for training the neural network 100 shown in FIG. 1. The training source S₁ may be in a form of images, videos, audios, texts, data, or other types of information suitable for training of artificial intelligence models. The training source S₁ is partitioned into multiple segments or parts as input activations of the neural network, denoted as a vector [x₁, x₂, . . . , x_{K}]. Each segment x₁, x₂, . . . , x_{K} of the training source S₁ is correlated to each other to constitute a complete piece of information, e.g., a picture of a dog, or a paragraph of human's speech.

The optical computing device 200 is configured to perform a MAC operation given the vector of input activations [x₁, x₂, . . . , x_{K}] and an array of weights [w₁, w₂, . . . , w_{K}] for an output activation y₁. Each of the K source pixels 302 is configured to emit an input optical beam/pulse with individual intensities based on the values of the input activations [x₁, x₂, . . . , x_{K}], and each of the K modulator pixels 307 is configured with a transmissivity or reflectivity based on the values of a vector of weights [w₁, w₂, . . . , w_{K}]. After the input optical beams/pulses propagate through the first optical element 304, the modulator pixels 307, and the second optical element 308, to arrive at the detector pixel 309, the modulated optical beams/pulses are accumulated and converted into an equivalent electric current or equivalent charges, which correspond to the value of the output activation. A MAC operation based on optical computing is thus accomplished.

FIG. 3A illustrates a block diagram of a spatial light multiplexer (SLM) 306A for optical computing, in accordance with some embodiments of the present disclosure. Referring to FIG. 3A, an input optical beam/pulse 322 is transmitted, e.g., from a source pixel 302, and is incident on the SLM 306A. According to some embodiments, the SLM 306A is a transmissive SLM that has an optical transmissive medium configured to modulate or filter the input optical beam/pulse 322, such that only a portion of the input optical beam/pulse 322 is allowed to pass through and becomes a modulated optical beam/pulse 324.

According to some embodiments, the SLM 306A is formed of a layer stack that includes a pair of polarizing layers or polarizer 311, a pair of substrates 312, a pair of conductive layers 314, a pair of alignment layers 316 and a liquid crystal layer 318. Although FIG. 3A only shows the abovementioned elements of the SLM 306A, the present disclosure is not limited thereto. More or fewer elements can be included in the SLM 306A.

According to some embodiments, the pair of polarizing layers 311 are arranged on the two outermost sides of the SLM 306A, and configured to provide different directions of polarization for the input optical beam/pulse and the modulated optical beam/pulse. The pair of polarizing layers 311 may be configured with different polarizations, e.g., perpendicular polarizations or other angles of polarizations. As a result, a portion of the input optical beam/pulse may be blocked from propagating through the SLM 306A. According to some embodiments, the pair of polarizing layers 311 are formed of polyvinyl alcohol (PVA) or other suitable materials. According to some embodiments, the pair of polarizing layers 311 are omitted from the SLM 306A.

According to some embodiments, the pair of substrates 312 are arranged between the pair of polarizing layers 311 and the pair of conductive layers 314. The substrates 312 may provide physical support for other layers such that other layers of the SLM 306A can be formed on the pair of substrates 312. According to some embodiments, the pair of substrates 312 are formed of transparent materials, such as glass, quartz, or other suitable materials.

Each of the conductive layers 314 are arranged between the substrate 312 and the alignment layer 316, and configured to receive biasing voltages from an external power source (e.g., the controller 310 shown in FIG. 2) and generate an electric field between the pairs of the conductive layers 314. According to some embodiments, the conductive layers 314 are formed of transparent materials, such as indium tin oxide (ITO) or other suitable transparent conductive oxide materials, conductive polymers, metal grids and random metal networks, carbon nanotubes, graphene, nanowire meshes, and the like.

According to some embodiments, each of the alignment layers 316 is arranged between the liquid crystal layer 318 and the conductive layer 314. The alignment layer 316 is configured to align the liquid crystal molecules between the alignment layers 316 in a helical twist, with the first layer molecule and last layer molecule formed perpendicular to each other. According to some embodiments, the pair of alignment layers 316 are formed of polyvinyl alcohol (PVA) or other suitable materials. According to some embodiments, the liquid crystal layer 318 is in an innermost layer of the SLM 306A and configured to control the transmissivity of the SLM 306A according to the direction of rotation of the liquid crystal molecules in the SLM 306A.

Although not separately shown, the SLM 306A can be partitioned into a plurality of modulator pixels 307 and perform modulations on each of the modulator pixels 307 according to different weights provided by the controller 310 shown in FIG. 2. During operation, when the SLM 306A is modulated according to a voltage differential, each modulator pixel 307 in the liquid crystal layer 318 can experience individual electric fields across it due to the different voltage differentials between the two conductive layers 314. This causes the liquid crystal molecules to align themselves in the direction of the individual electric fields. The relative orientation of the molecules and their birefringence property cause a phase modulation of the SLM 306A. According to some embodiments, amplitude modulation of the SLM 306A is achieved through the use of the pair of polarizing layers 311.

FIG. 3B illustrates a block diagram of an SLM 306B for optical computing, in accordance with some embodiments of the present disclosure. Referring to FIG. 3B, an input optical beam/pulse 322 is transmitted, e.g., from a source pixel 302, and is incident on the SLM 306B. According to some embodiments, the SLM 306 is a reflective SLM that has a reflective optical medium configured to modulate or filter the input optical beam/pulse 322, such that only a portion of the input optical beam/pulse 322 is allowed to reflect back and becomes a modulated optical beam/pulse 324 according to a driving optical beam 323.

According to some embodiments, the SLM 306B is formed of a layer stack that includes a polarizing layer 311, a pair of substrates 312, a pair of antireflection layers 313, a pair of conductive layers 314, a reflector 315, a pair of alignment layers 316, a silicon layer 317, and a liquid crystal layer 318. According to some embodiments, the SLM 306B is an optically addressed LCOS (liquid crystal on silicon) SLM, in which the liquid crystal layer 318 includes parallel aligned nematic liquid crystal molecules. Although FIG. 3B only shows the abovementioned elements of the SLM 306B, the present disclosure is not limited thereto. More or fewer elements can be included in the SLM 306B. Some components of the SLM 306B have been discussed with respect to the SLM 306A, and are not repeated for brevity.

According to some embodiments, the polarizing layer 311 is arranged between one of the antireflection layers 313 and the substrate 312 near one side on which the input optical beam/pulse is incident. According to some embodiments, the pair of antireflection layers 313 are arranged on the outermost layers of the SLM 306B. The antireflection layers 313 are configured to prevent or mitigate reflection of light at the interface between the SLM 306B and the environment to ensure allowing most of the input optical beam/pulse 322 to propagate into the SLM 306B and be reflected according to the determined reflectivity.

According to some embodiments, the reflector 315 is arranged between the liquid crystal layer 318 and the silicon layer 317, and configured to reflect the input optical beam/pulse 322 into reflected or modulated optical beam/pulse 324 with a determined reflectivity. According to some embodiments, the reflector 315 may be formed of a dielectric mirror or other suitable materials.

According to some embodiments, the silicon layer 317 is arranged between the reflector 315 and one of the conductive layers 314 adjacent to the side on which the driving optical beam is incident, and serves as a configurable resistor layer. Through changing the resistivity distribution of the silicon layer, the voltage differential values, and the resulting electric fields, across the liquid crystal molecules in the liquid crystal layer 318 can be different.

During operation, when the SLM 306B is modulated according to the voltage differential and the driving optical beam 323, the silicon layer 317 is configured to generate a pattern with a variable resistance distribution, thereby adjusting the overall voltage differential values in the locations of different modulator pixels 307 in the SLM 306B. This causes the liquid crystal molecules to align themselves in the direction of the individual electric fields. The relative orientation of the molecules and their birefringence property cause different phase modulations of different modulator pixels 307 on the SLM 306B. According to some embodiments, amplitude modulation of the SLM 306B is achieved through the use of the polarizing layer 311.

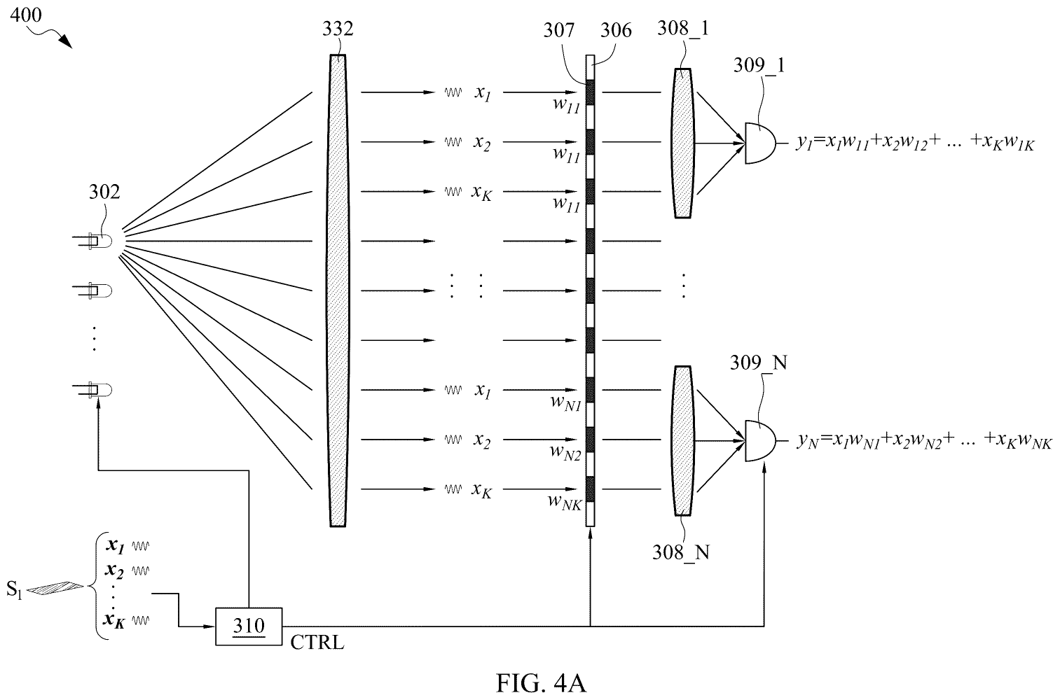

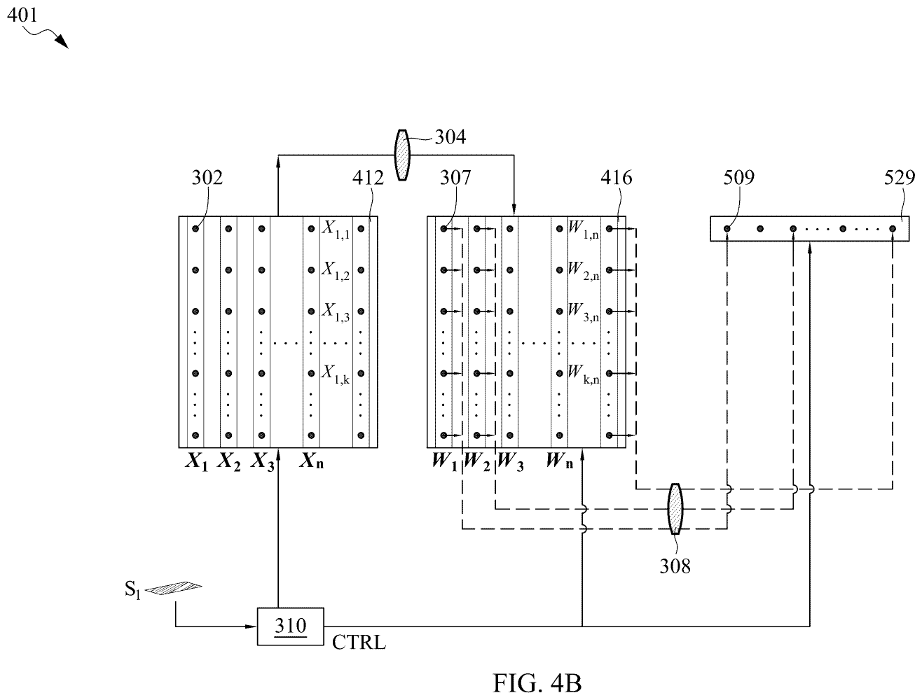

FIG. 4A shows a diagram of an optical computing device 400, in accordance with some comparative embodiments of the present disclosure. The optical computing device 400 includes an array of source pixels 302, a first optical element 332, an SLM 306 along with an array of modulator pixels 307, an array of second optical elements 308, and an array of detector pixels 309. Although FIG. 4A only shows the abovementioned elements of the optical computing device 400, the present disclosure is not limited thereto. More or fewer elements can be included in the optical computing device 400. Some components of the optical computing device 400 have been discussed with respect to the optical computing device 200, and are not repeated for brevity.

Referring to FIG. 4A, the training source S₁ is received or provided, and partitioned into multiple segments or parts as input activations of the neural network, denoted as a vector [x₁, x₂, . . . , x_{K}]. The input activations [x₁, x₂, . . . , x_{K}] may be sent to the controller 310, which is configured to correspond the values of the received input activations [x₁, x₂, . . . , x_{K}] to the intensities of an array of input optical beams/pulses. According to some embodiments, the controller 310 is further configured to control the array of source pixels 302 to transmit the array of input optical beams/pulses based on the input activations [x₁, x₂, . . . , x_{K}]. Although FIG. 4A shows that the source pixels 302 are arranged in a row or column, the present disclosure is not limited thereto. The source pixels 302 can also be arranged in an array shape with an adjustable row number and an adjustable column number.

According to some embodiments, the K input optical beams/pulses are fanned out to be N sets of copies of the K input optical beams/pulses through the first optical element 332. Since the fan-out operation is achieved by the first optical element 332, the optical computing device 400 is thus referred to as an “optical fan-out” optical computing device. According to some embodiments, the first optical element 332 includes a lens, a mirror, a meta-lens, a combination thereof, or the like, and configured to generate N copies of each of the K input optical beams/pulses. The first optical element 332 may also include a diffractive lens, a concave lens, a convex lens, or the like. Although FIG. 4A shows that the fanned-out input optical beams/pulses are arranged in a row or a column, the present disclosure is not limited thereto. The fanned-out input optical beams/pulses may be arranged with a combination of multiple subarrays with each subarray including a set of K input optical beams/pulses that represent the input activations [x₁, x₂, . . . , x_{K}]. As a result, the fanned-out input optical beams/pulses can be represented by a matrix of input activations [x_{k,n}], where the row index k is a natural number starting from one to K, and the column index n is a natural number starting from one to N, where K is the length of the input activations while N is the column number of the weights of the neural network 100, as represented in Equation (1).

According to some embodiments, the controller 310 is further configured to determine the transmissivity or reflectivity of the modulator pixels 307 on the SLM 306 according to the matrix of weights [w_{k,n}]. Each of the fanned-out input optical beams/pulses (corresponding to input activations [x_{k,n}]) is imaged onto the corresponding modulator pixels 307 (corresponding to weights [w_{k,n}]) to realize the optical coupling of the source pixels 302 and the corresponding modulator pixels 307. The abovementioned modulation step is equivalent to the multiplication step in the MAC operation.

Subsequently, each set of the K modulated optical beams/pulses are converged or fanned in to a respective detector pixel 309 (e.g., detector pixels 309_1, 309_2, . . . , 309_N) through a respective second optical element 308 (e.g., second optical elements 308_1, 308_2, . . . , 308_N). According to some embodiments, the second optical element 308 is configured to adjust the optical properties of the modulated optical beams/pulses transmitted by the modulator pixels 307 before they are incident on the respective detector pixel 309 in a receiver of the optical computing device 400. The second optical element 308 may include a lens, a mirror, a meta-lens, a combination thereof, or the like. According to some embodiments, the second optical element 308 includes a converging or concave lens configured to direct the modulated optical beams/pulses to the respective detector pixel 309 in the receiver.

According to some embodiments, each of the detector pixels 309 includes a photodetector or a photodiode configured to receive the modulated optical beams/pulses transmitted via the respective second optical element 308. According to some embodiments, the detector pixel 309 is configured to accumulate the modulated optical beams/pulses from each modulator pixel 307 of the same set, and convert the accumulated photons of the optical beams/pulses into an electric current or charges. The value of the electric currents or charges correspond to values of the respective output activations, i.e., [y₁, y₂, . . . y_{N}], of the neural network 100. For example, the multiplication-accumulation operation for the first output activation y₁ represented by the electric current of the detector pixel 309_1 is expressed by the following Equation (2):

$${y}_{1} = {x}_{1} {w}_{11} + {x}_{1} {w}_{12} + ... . + {x}_{K} {w}_{1 K} , \qquad ( 2 )$$

Similarly, the multiplication-accumulation operation for the last output activation y_{N} represented by the electric current of the detector pixel 309_N is expressed by the following Equation (3):

$${y}_{N} = {x}_{1} {w}_{N 1} + {x}_{1} {w}_{N 2} + ... . + {x}_{K} {w}_{NK} \qquad ( 3 )$$

The abovementioned light accumulation and charge conversion step is equivalent to the accumulation step in the MAC operation.

FIG. 4B shows a diagram of an optical computing device 401, in accordance with some comparative embodiments of the present disclosure. The optical computing device 401 includes a source panel 412 having a K-by-N matrix of source pixels 402, the first optical element 304, a modulator panel 416 having a K-by-N matrix of modulator pixels 406 serving as an SLM, a plurality of the second optical elements 308, and a detector panel 419 having an N-by-1 array of detector pixels 409. The optical computing device 401 may perform the same MAC operation with a structure similar to that of the optical computing device 400, where the source pixels 402, the modulator pixels 406 and the detector pixels 409 correspond to the matrix of source pixels 302, the matrix of modulator pixels 307, and the array of detector pixels 309, respectively. The first optical element 304 and second optical elements 308 have been discussed with respect to the optical computing device 400, and are not repeated for brevity.

According to some embodiments, the source panel 412 is formed of a liquid crystal display (LCD) panel with a matrix of source pixels 302 formed thereon, where the source pixels 302 are formed of LCD pixels. The source panel 412 can also be formed of a light-emitting diode (LED) display panel with a matrix of source pixels 302 formed thereon, where the source pixels 302 are formed of VCSELs or LEDs, such as OLED, mini LED, micro LED. Similarly, the modulator panel 416 is formed of a liquid crystal display (LCD) panel with a matrix of modulator pixels 307 formed thereon, where the modulator pixels 307 are formed of LCD pixels. Moreover, the detector panel 419 can also be formed with an array of detector pixels 309 formed thereon, where the detector pixels 309 are formed of photodetectors or photodiodes.

According to some embodiments, the controller 310 is configured to duplicate the first column of the source panel 412 to the other N-1 columns of the source panel 412. Therefore, the N columns of source pixels 302 on the source panel 412 would be configured to emit the input optical beams/pulses with identical input activations X=[x₁, x₂, . . . , x_{K}]. This is equivalent to the optical fan-out step performed by the first optical element 332 of the optical computing device 400, but is implemented in a matrix of pixels on a panel. In other words, the source pixels 302 at the same row but in different columns of the source panel 412 is electrically interconnected. As a result, the controller 310 is required to just transmit the control signals to only the first column or any one of the N column in order to finish configuring all source pixels 302 since all of the columns have been electrically connected together row by row. This can be also seen as indicated by the duplicated labels of x₁'s near the bottom of each column of the source panel 522. The control complexity would further be simplified.

According to some embodiments, the modulator pixels 307 of the modulator panel 416 are configured according to the matrix of the weights [w_{n,k}]. The source pixels 302 are imaged onto the corresponding matrix of modulator pixels 307 on the modulator panel 416. According to some embodiments, the first optical element 304 may be omitted if the alignment and focusing of the source pixels 302 are well controlled so that the direct imaging of the source pixels 302 onto the modulator pixels 307 is deemed successful.

According to some embodiments, the modulated optical beams/pulses are fanned in to a respective detector pixel 309 on the detector panel 419 through the respective second optical elements 308.

The optical computing devices 400 and 401 can provide advantages of optical computing in realizing the MAC operations in its fast processing time and low energy consumption as compared to its electrical counterpart. According to some embodiments, the length K of the input activation [xₖ] is determined by the size of the source panel 412 and the number N of columns of the weight [w_{k,n}], or the length N of the output activations [yₙ]. For example, if the total number of modulator pixels 307 of the modulator panel 416 is M2*N2 (the parameters M2, N2 are natural numbers) then the number K of the input activations [xₖ] is constrained by the upper limit M2*N2/N. Therefore, the length or type of the training source S₁ is restricted to relatively small-size training data accordingly.

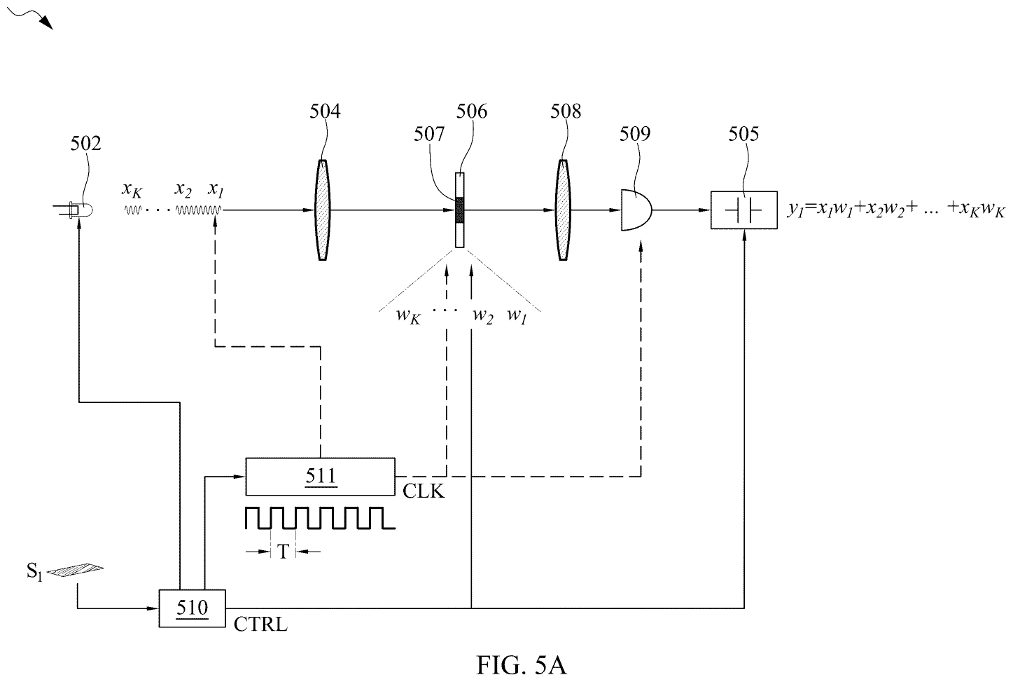

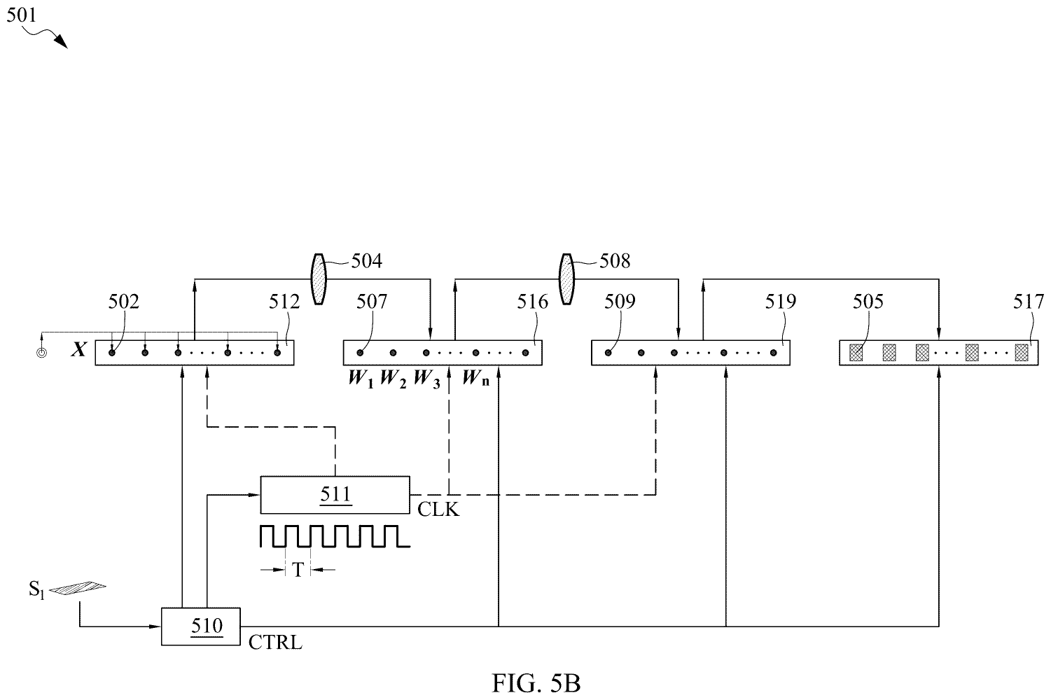

FIG. 5A shows a diagram of an optical computing device 500, in accordance with some embodiments of the present disclosure. The optical computing device 500 may be used to implement the neural network 100 shown in FIG. 1. The optical computing device 500 is operated in the optical domain, and performs at least part of the MAC operations based on optical signal processing. For example, an algebraic accumulation operation of multiple input activations is performed by optically converging multiple optical signals that represent the input activations and outputting the converged or fanned-in optical signal that represents the output activation. Further, an algebraic multiplication operation of an input activation by a multiplier can be realized by optically directing an optical signal that represents the input activation to an optical element with a controllable transmissivity or reflectivity value, and outputting the acquired output optical signal through the optical element as the output activation.

The optical computing device 500 includes a source pixel 502, a first optical element 504, an SLM 506, a second optical element 508, a detector pixel 509, a controller 510, a clock generator 511 and an integrator 505. The SLM 506 has a modulator pixel 507 formed thereon. Although FIG. 5A only shows the aforementioned elements of the optical computing device 500, the present disclosure is not limited thereto. There may be more or fewer elements included in the optical computing device 500 in other embodiments. Some components of the optical computing device 500, e.g., the source pixel 502, the first optical element 504, the SLM 506, the modulator pixel 507, the second optical element 508, and the detector pixel 509, are similar to their respective counterpart elements in the optical computing device 200, e.g., the source pixel 302, the first optical element 304, the SLM 306, the modulator pixel 307, the second optical element 308, and the detector pixel 309, and therefore their descriptions are not repeated for brevity.

Referring to FIG. 5A, the training source S₁ is received or provided, and partitioned into multiple segments or parts as input activations of the neural network 100, denoted as an array [x₁, x₂, . . . , x_{K}]. The input activations [x₁, x₂, . . . , x_{K}] may be sent to the controller 510, which is configured to convert the received input activations [x₁, x₂, . . . , x_{K}] into an array of input optical pulses. According to some embodiments, the controller 510 is further configured to control source pixel 502 to determine the intensities of the array of input optical pulses based on the values of the input activations [x₁, x₂, . . . , x_{K}].

The source pixel 502 is a single source pixel 502 that is configured to transmit the K input optical pulses in a time-multiplexing manner with a predetermined time interval T. The clock generator 511 is configured to generate a clock signal with the time interval T to manage the different transmission times of the source pixel 502 for the input optical pulses. The clock generator 511 may also be configured to synchronize transmission times of the plurality of input optical pulses by the source pixel 502 with modulation times of the modulator pixel 507 on the SLM 506. According to some embodiments, the controller 510 is configured to transmit control signals to manage the clock generator 511. The controller 510 may be configured to determine or receive the value of the time interval T and transmit the same to the clock generator 511.

According to some embodiments, the K input optical pulses are transmitted through the first optical element 504 and directed to the modulator pixel 507 of the SLM 506. According to some embodiments, the modulator pixel 507 is a single modulator pixel 507 configured to modulate the input optical pulses transmitted by the source pixel 502 according to the corresponding weights [w₁, w₂, . . . , w_{K}]. The modulation steps on the K input optical pulses are performed in a time-multiplexing manner with the time interval T. According to some embodiments, the clock generator 511 is configured to generate the clock signal with the time interval T to control the modulation times and intervals of the modulator pixel 507. The abovementioned modulation step is equivalent to the multiplication step in the MAC operation. According to some embodiments, the clock generator 511 is integrated into the controller 510 such that the controller 510 is capable of generating clock signals and control signals to the source pixel 502, the SLM 506, the detector pixel 509 and the integrator 505.

The modulated optical pulses are transmitted through the second optical element 508 and directed to the detector pixel 509. The detector pixel 509 is configured to collect and accumulate the K modulated optical pulses by the photodetector/photodiode of the detector pixel 509 in a time-multiplexing manner with the time interval T. The detector pixel 509 may be further configured to convert the K modulated optical pulses into K respective electric currents or charges, and transmit the K electric currents or charges to the integrator 505.

According to some embodiments, the integrator 505 is configured to integrate the electric currents or charges of the electric currents transmitted by the detector pixel 509. The integrated charges or electric currents are converted to a corresponding value and sent back to the controller 510, and converted to the output activation y₁. The integrator 505 may include a capacitor, or other integrator circuit including operational amplifiers. The abovementioned accumulation of the modulated optical pulses and integration of the converted charges/currents is equivalent to the accumulation step in the MAC operation. As a result, the output activation y₁ can be expressed by Equation (4) shown below.

$${y}_{1} = {x}_{1} {w}_{1} + {x}_{2} {w}_{2} + ... . + {x}_{K} {w}_{K} \qquad ( 4 )$$

As far as an arbitrary output activation yₙ is concerned, if the mathematical representations of the input activations [x₁, x₂, . . . , x_{K}], the weights [w₁, w₂, . . . w₁,k, . . . w_{K}] and the output activation [y₁, y₂, . . . yₙ . . . , y_{N}] are extended into respective matrix forms [x_{1,1}, x_{1,2}, . . . x_{1,k} . . . , x_{1,K}], [w_{k,n}|1≤k≤K, 1≤n≤N], and [y_{1,1}, y_{1,2}, . . . y_{1,n} . . . , y_{1,N}], respectively, the n-th output activation y₁,n can be expressed by Equation (5) shown below:

$${\sum }_{k}^{K} {x}_{1 , k} {w}_{k , n} = {y}_{1 , n} \qquad ( 5 )$$

The optical computing device 500 provides advantages over the optical computing device 200, 400 or 401. Different from the multiplication step realized by the source pixels 302 and the modulator pixels 307 of the SLM 306 in a space-multiplexing manner, the multiplication step realized by the single source pixel 502 and the single modulator pixel 507 are performed in a time-multiplexing manner. The hardware cost and device footprint of the optical computing device 500 thus can be greatly reduced as compared to the optical computing device 200 or 400, and is independent of the length K of the input activations.

Further, according to some embodiments, since the input optical pulses are transmitted by a single source pixel 502, modulated by a single modulator pixel 507 and accumulated by a single detector pixel 509, the optical paths of the optical computing device 500 has only a single incident angle, which is the normal to the modulator pixel 507 or to the detector pixel 509, different from the various incident angles of the fan-out input optical pulses by the first optical element 332 or the fan-in modulated optical pulses by the second optical element 308. The energy loss or noise generated by the fan-out or fan-in operations performed by the first optical element 332 or the second optical elements 308 are greatly reduced or eliminated in the optical computing device 500. The optical coupling efficiency and accuracy can therefore be significantly improved.

In addition, the processing time for generating a single output activation y₁ for optical computing device 500 is larger than that of the optical computing device 400 or 401, and is dependent upon the time interval T and the length K of the input activations [x₁, x₂, . . . , x_{K}]. However, in a practical use scenario, the time delay is unnoticeable. For example, given a relative long sequence of the input activations [x₁, x₂, . . . , x_{K}] with K equal to about 8 million and the time interval T substantially equal to 1e(−9) seconds under the operation of a clock generator with a Giga-Hertz sampling rate, the average time delay for generating an output activation is about 0.008 seconds. Based on the above, the time delay of the optical computing device 500 can be neglected.

FIG. 5B shows a diagram of an optical computing device 501, in accordance with some embodiments of the present disclosure. The optical computing device 501 includes a source panel 512 with a 1-by-N array of source pixels 502, a 1-by-N array of the first optical elements 504, a modulator panel 516 with a 1-by-N array of modulator pixels 507 serving as an SLM, a 1-by-N array of the second optical elements 508, a detector panel 519 with a 1-by-N array of detector pixels 509, and an integrator panel 517 having a 1-by-N array of integrators 505 formed thereon. The optical computing device 501 may perform the same MAC operation with a structure similar to that of the optical computing device 500, where the first optical elements 504 and second optical elements 508 have been discussed with respect to the optical computing device 500, and are not repeated for brevity.

According to some embodiments, the source panel 512 is formed of a liquid crystal display (LCD) panel with an array of source pixels 502 formed thereon, where the source pixels 502 are formed of LCD pixels. The source panel 512 can also be formed of a light-emitting diode (LED) display panel with an array of source pixels 502 formed thereon, where the source pixels 502 are formed of VCSELs or LEDs, such as OLED, mini LED, micro LED, or the like. Similarly, according to some embodiments, the modulator panel 516 is formed of a liquid crystal display (LCD) panel with an array of modulator pixels 507 formed thereon, where the modulator pixels 307 are formed of LCD pixels. Moreover, according to some embodiments, the detector panel 519 can also be formed of a panel with an array of detector pixels 509 formed thereon, where the detector pixels 509 are formed of photodetectors or photodiodes. According to some embodiments, the integrator panel 51 is also formed of a panel with an array of integrators 505 formed thereon, where the integrators 505 are formed of capacitors or integrator circuits.

According to some embodiments, the controller 510 is configured to duplicate the first source pixel 502 of the source panel 512 to the remaining N-1 source pixels 502 of the source panel 512. The N source pixels 502 may be electrically interconnected. Therefore, the N source pixels 502 on the source panel 512 would be configured to emit the input optical pulses with identical input activations X=[x₁, x₂, . . . , x_{K}] spaced by the identical time interval T. This is equivalent to the optical fan-out step performed by the first optical element 332 of the optical computing device 400, but is implemented in a time-multiplexing manner on a panel. The input optical pulses are fanned out in time domain through control of an electrical clock signal, and therefore the optical computing device 501 is also referred to as an “electrical fan-out” optical computing device. As a result, the controller 510 is required to just transmit the control signals to the first source pixel 502 only or any one of the source pixels 502 in order to finish configuring all source pixels 502 since all source pixels 502 have been electrically connected together, as indicated by the solid line connected the entries of the source pixels 502 of the source panel 522. The control complexity would be further simplified.

According to some embodiments, the modulator pixels 507 of the modulator panel 516 are configured according to the matrix of the weights [wₙ,k], where the n-th modulator pixel 507 is configured to be modulated according to the K entries of the n-th column in the matrix of the weights (i.e., the weight represented in the form of the entries [wₙ]=[w_{n,1}; w_{n,2}, . . . ; w_{n, K}.] for the n-th column) successively with the time interval T. The n-th source pixel 502 is then imaged onto the corresponding n-th modulator pixel 507, through the n-th first optical elements 504, on the modulator panel 516 K times paced by the time interval T to effect the optical coupling between the input optical pulses for the input activation X=[x₁, x₂, . . . , x_{K}] and modulator pixels 507 for the n-th column of the weights [wₙ]=[w_{n,1}; w_{n,2}, . . . ; w_{n,K}.] in a time-multiplexing manner. According to some embodiments, the n-th first optical element 504 is omitted since the alignment and focusing of the source pixels 502 with respect to the respective modulator pixels 507 are achieved by simply one-one one pixel mapping and, therefore, their optical coupling performance are well managed without the n-th first optical element 504.

According to some embodiments, each set of K modulated optical pulses of the n-th modulator pixel 507 are transmitted, through the n-th second optical element 508, and imaged onto the n-th detector pixels 509 on the detector panel 519 K times spaced by the time interval T. According to some embodiments, each set of the K modulated optical pulses for the n-th modulator pixel 507 are converted by the n-th detector pixel 509 into respective K electric currents or K groups of charges. According to some embodiments, the n-th second optical element 508 is omitted since the alignment and focusing of the modulator pixels 507 with respect to the respective detector pixels 509 are achieved by simply one-one one pixel mapping and, therefore, their optical coupling performance are well managed without the n-th second optical element 508.

According to some embodiments, each set of the K electric currents or K groups of charges in the n-th detector pixel 509 are accumulated or integrated by the n-th integrator 505 to provide the value corresponding to the output activations yₙ. The overall output activations can be acquired by the N integrators 505 as [y₁, y₂, . . . , y_{N}].

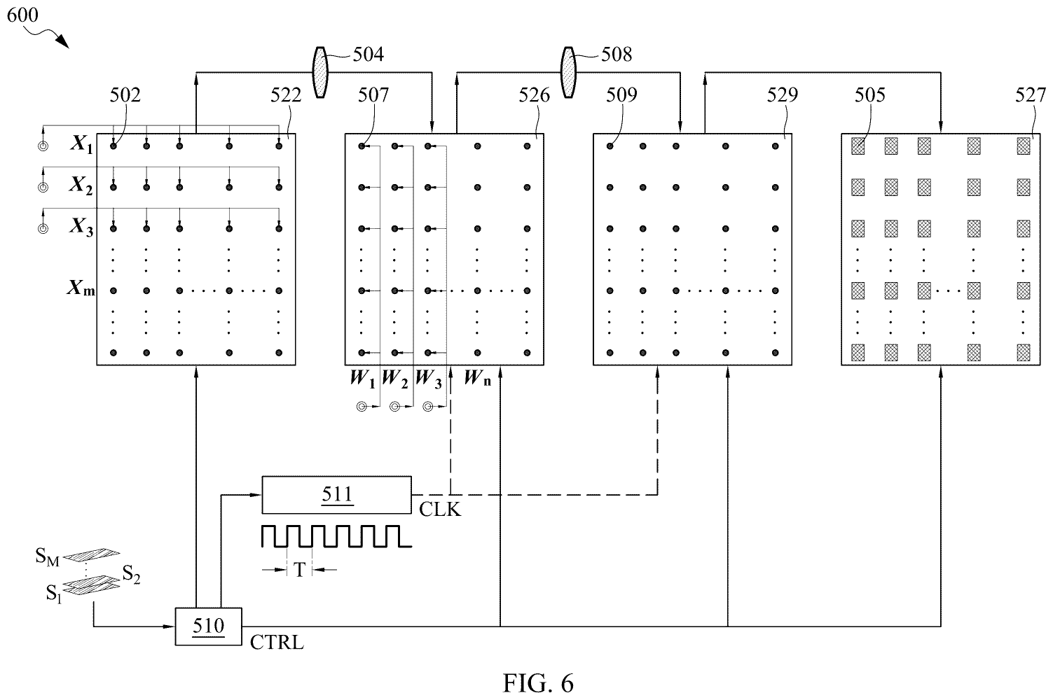

FIG. 6 shows a diagram of an optical computing device 600, in accordance with some embodiments of the present disclosure. The optical computing device 600 is seen as an expanded version of the optical computing device 501 in that the optical computing device 600 can simultaneously process multiple flows of training data based on different pieces of training sources S₁, S₂, . . . Sₘ, . . . S_{M}, where the parameters M, m are natural numbers and m is in a range from one to M. Each training flow for performing the MAC operations with respect to the training source Sₘ is similar to that performed by the optical computing device 501 for the training source S₁.

Referring to FIG. 6, the optical computing device 600 includes a source panel 522 with an M-by-N matrix of a source pixels 502, an M-by-N matrix of the first optical elements 504, a modulator panel 526 with an M-by-N matrix of a modulator pixels 507 as an SLM, an M-by-N matrix of the second optical elements 508, a detector panel 529 with an M-by-N matrix of a detector pixels 509, and an integrator panel 517 with an M-by-N matrix of integrators 505. The source panel 522, the modulator panel 526, the detector panel 529 and the integrator panel 527 may correspond to the source panel 512, the modulator panel 516, the detector panel 519 and the integrator panel 517, respectively, of the optical computing device 501 with expanded sizes. The matrix of the first optical elements 504 and the matrix of the second optical elements 508 have been discussed with respect to the optical computing device 500 or 501, and are not repeated for brevity.

Multiple training sources S₁ through S_{M} are received or provided for training different neural networks each being like the neural network 100 shown in FIG. 1. The training sources S₁ through S_{M} may be independent from each other.

According to some embodiments, the N source pixels 502 in the m-row of the source panel 522 are used to receive the m-th training source Sₘ. In other words, the M training flows running on the M rows of the source panel 522 are performed simultaneously in a space-multiplexing manner. For each training flow for the training sources Sₘ, the source pixels 502 in the m-th row of the source panel 522 are configured to generate or transmit K input optical pulses according to the K input activations of the m-th training source, in which the input activations are represented as [X_{m,k}] or simply [Xₘ], in which the index m represents the index of the training source Sm, and the index k represents the k-th input activation of the m-th training source to be transmitted at the k-th time instant. In a similar arrangement to the source panel 512, the N source pixels 502 in the same row of the source panel 522 are electrically interconnected, as indicated by the solid lines connected the entries of the source pixels 502 on the same row for the first three rows of the source panel 522. That means the input activations [Xₘ] are identical for the N source pixels 502 for the m-th row of the source panel 522, and the N source pixels 502 in the same row are configured to transmit identical input optical pulses with identical time intervals T for each column of the source panel 522.

According to some embodiments, the modulator pixels 507 of the modulator panel 526 are configured according to the matrix of the weights [w_{n,k}^{m}] for the [n,k]-th weight of the m-th training source Sₘ. The [m, n]-th modulator pixel 507 in the m-th row and n-th column of the modulator panel 526 is configured to be modulated according to the K entries of the n-th column in the matrix of the weights, i.e., [wₙ^{m}]=[w_{n,1}^{m}; w_{n,2}^{m}; . . . w_{n,k}^{m}; . . . ; w_{n,k}^{m}] successively with the time interval T. The n-th source pixel 502 on the m-row of the source panel 522 is then imaged onto the corresponding n-th modulator pixel 507, through the [n, m]-th first optical element 504, on the m-th row of the modulator panel 516 by K times with the time interval T to effect the optical coupling between the input optical pulses for the input activation X=[x_{m,1}, x_{m,2}, . . . , x_{m,K}] of the m-th training source Sₘ and modulator pixels 507 for the n-th column of the weights [wₙ^{m}]=[w_{n,1}^{m}; w_{n,2}^{m}; . . . w_{n,k}^{m}; . . . w_{n,k}^{m}] in a time-multiplexing manner. According to some embodiments, the [n, m]-th first optical element 504 is omitted since the alignment and focusing of the [n, m]-th source pixel 502 with respect to the corresponding [n, m]-th modulator pixel 507 are achieved by simply one-one one pixel mapping and, therefore, their optical coupling performance are well managed without the [n, m]-th first optical element 504.

According to some embodiments, the training sources S₁ through Sₘ are used to train the same neural network 100, and therefore the weights are kept unchanged for different index m. Therefore, the weights can be simplified as [wₙ^{m}]=[wₙ]=[w_{n,1}; w_{n,2}; . . . w_{n,k}; . . . w_{n, K}] for all m's. Under such conditions, the M modulator pixels 507 on the same column would be modulated with M identical weights [w_{n,k}] spaced by the identical time intervals T. According to some embodiments, as shown in FIG. 6, the modulator pixels 507 on the same column of the modulator panel 516 are electrically interconnected, as indicated by the solid lines connected the entries of the modulator pixels 507 on the same column for the first three columns of the modulator panel 526. The control complexity would be further simplified.

According to some embodiments, each set of K modulated optical pulses of the [m, n]-th modulator pixel 507 for the m-th training source Sₘ are transmitted, through the [m, n]-th second optical element 508, and imaged onto the [m, n]-th detector pixels 509 on the detector panel 529 with the time interval T. According to some embodiments, each set of the K modulated optical pulses for the [m, n]-th modulator pixel 507 are converted by the [m, n]-th detector pixel 509 into respective electric currents or groups of charges. According to some embodiments, the [m, n]-th second optical element 508 is omitted since the alignment and focusing of the [m, n]-th modulator pixels 507 with respect to the [m, n]-th detector pixels 509 are achieved by simply one-one one pixel mapping and, therefore, their optical coupling performance are well managed without the [m, n]-th second optical element 508.

According to some embodiments, each set of the K electric currents in the [m, n]-th detector pixel 509 are accumulated or integrated by the [m, n]-th integrator 505 of the integrator panel 527 to provide the value corresponding to the [m, n]-th output activation yₙ^{m}. The overall output activations can be acquired by the N integrators 505 as [y₁^{m}, y₂^{m}, . . . , y_{N}^{m}] for the m-th training source Sₘ.

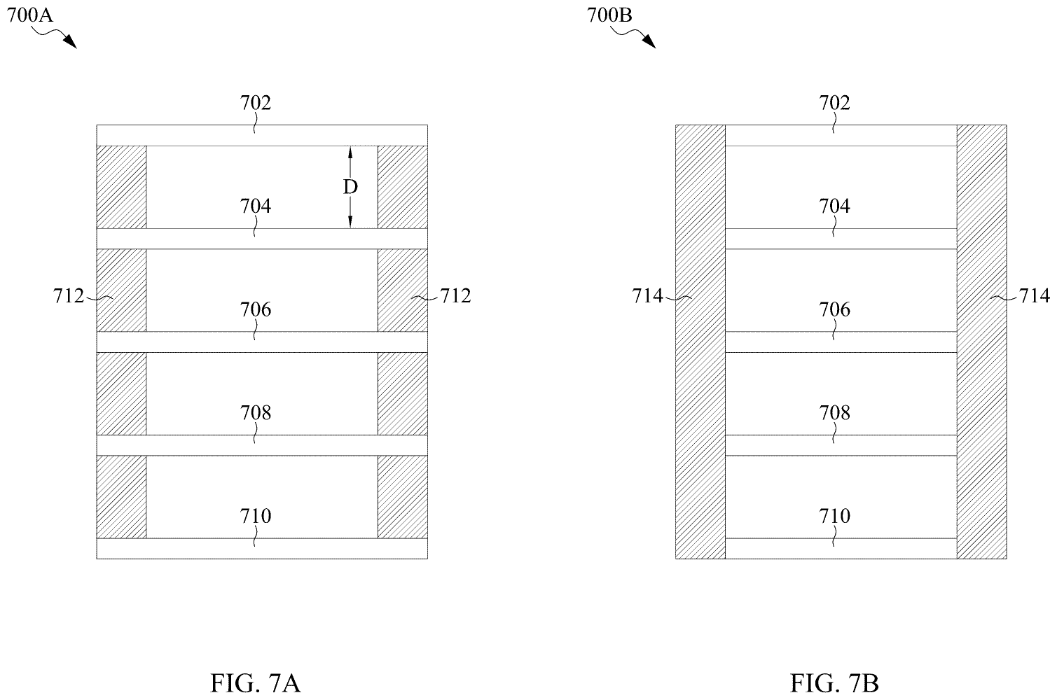

FIG. 7A shows a semiconductor optical computing device 700A, in accordance with some embodiments of the present disclosure. According to some embodiments, the semiconductor optical computing device 700A is used to implement the optical computing device 500, 501 or 600. The semiconductor optical computing device 700A includes a source substrate 702, a first optics substrate 704, a modulator substrate 706, a second optics substrate 708, and a detector substrate 710 arranged parallel to each other and spaced apart from each other. The semiconductor optical computing device 700A further includes spacers 712 between the aforementioned substrates 702-710. Although FIG. 7A only shows the aforementioned elements of the semiconductor optical computing device 700A, the present disclosure is not limited thereto. There may be more or fewer elements included in the semiconductor optical computing device 700A in other embodiments.

According to some embodiments, the source panel 512 or 522, the modulator panel 516 or 526, and the detector panel 519 or 529 are formed on the source substrate 702, the modulator substrate 706 and the detector substrate 710, respectively. The detector substrate 710 may also include the integrator panel 517 or 527 having the integrators 505 formed thereon. According to some embodiments, the first optical element 504 and the second optical element 508 are formed on the first optics substrate 704 and the second optics substrate 708, respectively. According to some embodiments, in order to ensure the optical pulses can propagate smoothly in the semiconductor optical computing device 700A, each of the source substrate 702, the first optics substrate 704, the modulator substrate 706 and the detector substrate 710 is formed of a transparent substrate formed of glass, quartz, or other suitable transparent materials. The source substrate 702 and detector substrate 710 may also be formed of a non-transparent semiconductor substrate, such as silicon, germanium, or other suitable semiconductor materials if these substrates do not form obstacles of propagation of the optical pulses.

Each adjacent pairs of the source substrate 702, the first optics substrate 704, the modulator substrate 706, the second optics substrate 708, and the detector substrate 710 may be spaced apart from each other by a spacing D. The spacing D may be in a range between an order of millimeters to an order to micron or sub-micron meters, depending upon the design requirements of the first optics substrate 704 or the second optics substrate 708. The spacing D may be substantially equal or unequal between different adjacent pairs of the abovementioned substrates 702-710.

The spacers 712 are arranged between each adjacent pairs of the source substrate 702, the first optics substrate 704, the modulator substrate 706, the second optics substrate 708, and the detector substrate 710. The spacers 712 are used to provide physical support and spacing fixation of the semiconductor optical computing device 700A. The spacers 712 may include a closed ring shape from a top-view perspective. According to some other embodiments, the spacers 712 include a plurality of pillars distributed at the periphery of the aforementioned substrates 702-710. The spacers may be formed of a molding material, an encapsulating material, or other suitable materials. According to some embodiments, the empty spaces between the adjacent pairs of the substrates 702-710 are kept at a low air pressure condition, filled with air, or filled with a transparent material, such as plastics or polymers.

FIG. 7B shows a semiconductor optical computing device 700B, in accordance with some embodiments of the present disclosure. The semiconductor optical computing device 700B is similar to the semiconductor optical computing device 700A in many aspects, and thus these similar features are not repeated for brevity. The main difference between the semiconductor optical computing device 700B and the semiconductor optical computing device 700A is the arrangement of spacers 714 in place of the spacers 712. The spacers 714 are laterally surrounding the source substrate 702, the first optics substrate 704, the modulator substrate 706, the second optics substrate 708, and the detector substrate 710. According to some embodiments, the source substrate 702, the first optics substrate 704, the modulator substrate 706, the second optics substrate 708, and the detector substrate 710 are clamped by the spacers 714 at the perimeters of the aforementioned substrates 702-710.

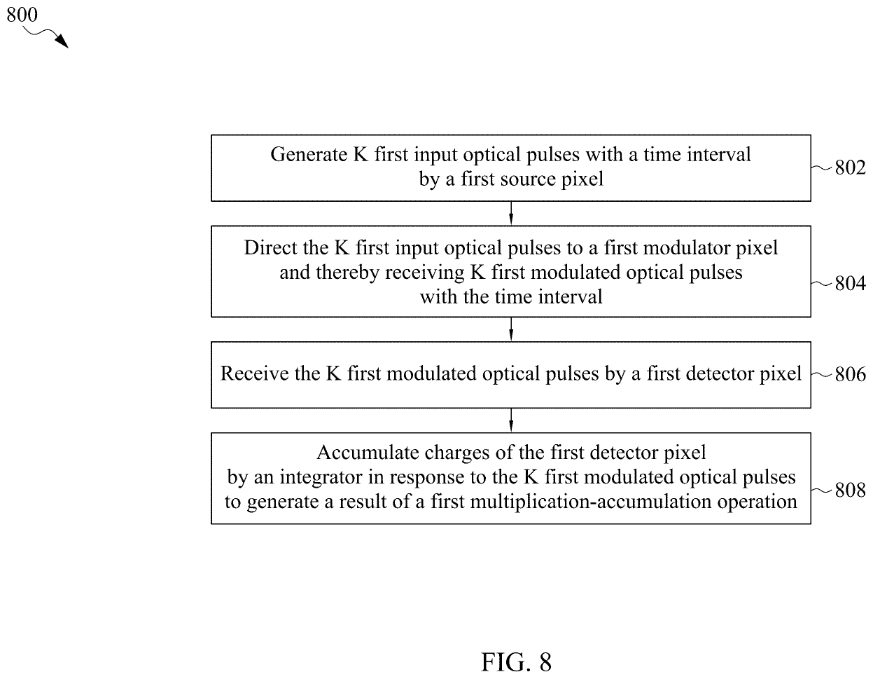

FIG. 8 shows a schematic flow chart of a method 800 of operating a semiconductor optical computing device, in accordance with some embodiments of the present disclosure. It shall be understood that additional steps can be provided before, during, and after the steps in method 800, and some of the steps described below can be replaced with other embodiments or eliminated. The order of the steps shown in FIG. 8 may be interchangeable. Some of the steps may be performed concurrently or independently.

At step 802, K first input optical pulses are generated with a time interval by a first source pixel, where K is a natural number.

At step 804, the K first input optical pulses are directed to a first modulator pixel and thereby K first modulated optical pulses are received with the time interval, wherein the first modulator pixel is configured to be modulated, in correspondence with the K first input optical pulses, according to K first weights.

At step 806, the K first modulated optical pulses are received by a first detector pixel.

At step 808, charges which are generated in response to the K first modulated optical pulses are accumulated by an integrator to generate a result of a first multiplication-accumulation operation.

In accordance with one embodiment of the present disclosure, an optical circuit includes: a source pixel configured to generate a plurality of input optical pulses with a time interval; a modulator pixel optically coupled to the source pixel and configured to modulate the plurality of input optical pulses to generate a plurality of modulated optical pulses; a detector pixel optically coupled to the modulator pixel and configured to generate charges in response to the plurality of modulated optical pulses; and a controller configured to electrically control an intensity of each of the plurality of input optical pulses and modulation levels of the modulator pixel to perform a multiplication-accumulation operation.

In accordance with one embodiment of the present disclosure, an optical circuit includes: an M-by-N matrix of source pixels each configured to generate a plurality of input optical pulses with a time interval, wherein M and N are natural numbers; n M-by-N matrix of modulator pixels optically coupled to the matrix of source pixels, each of the modulator pixels configured to modulate the plurality of input optical pulses with individual transmissivities or reflectivities to generate a plurality of modulated optical pulses; an M-by-N matrix of detector pixels optically coupled to the matrix of modulator pixels, each of the detector pixels configured to generate charges in response to the plurality of modulated optical pulses from a corresponding one of the modulator pixels; and a controller configured to electrically control an intensity of each of the plurality of input optical pulses of each of the source pixels and the individual transmissivities or reflectivities of each of the modulator pixels to perform a multiplication-accumulation operation.

In accordance with one embodiment of the present disclosure, a method of performing optical computing for an artificial intelligence accelerator includes: generating K first input optical pulses with a time interval by a first source pixel, K being a natural number; directing the K first input optical pulses to a first modulator pixel and thereby receiving K first modulated optical pulses with the time interval, wherein the first modulator pixel is configured to be modulated, in correspondence with the K first input optical pulses, according to K first weights; receiving the K first modulated optical pulses by a first detector pixel; and accumulating charges of the first detector pixel by an integrator in response to the K first modulated optical pulses to generate a result of a multiplication-accumulation operation.

The foregoing outlines structure of several embodiments so that those skilled in the art may better understand the aspects of the present disclosure. Those skilled in the art should appreciate that they may readily use the present disclosure as a basis for designing or modifying other operations and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. An optical circuit, comprising:
a source pixel configured to generate a plurality of input optical signals with a time interval;
a modulator pixel optically coupled to the source pixel and configured to modulate the plurality of input optical signals to generate a plurality of modulated optical pulses signals;
a detector pixel optically coupled to the modulator pixel and configured to generate charges in response to the plurality of modulated optical signals; and
a controller configured to electrically control an intensity of each of the plurality of input optical signals and modulation levels of the modulator pixel to perform a multiplication-accumulation operation.

2. The optical circuit of claim 1, further comprising a clock generator to synchronize each of the plurality of input optical signals with modulation times of the modulator pixel.

3. The optical circuit of claim 1, wherein the modulator pixel comprises an optically transmissive medium with a variable transmissivity, wherein the modulating of the plurality of input optical signals comprises modulating the plurality of input optical signals with individual transmissivities of the modulator pixel.

4. The optical circuit of claim 1, wherein the modulator pixel comprises an optically reflective medium with a variable reflectivity, wherein the modulating of the plurality of input optical signals comprises modulating the plurality of input optical signals with individual reflectivities of the modulator pixel.

5. The optical circuit of claim 1, further comprising an integrator configured to accumulate the charges generated by the detector pixel to provide a value corresponding a result of the multiplication-accumulation operation.

6. The optical circuit of claim 1, further comprising a first optical element between the source pixel and the modulator pixel, and configured to direct the plurality of input optical signals to the modulator pixel.

7. The optical circuit of claim 1, further comprising a second optical element between the modulator pixel and the detector pixel, and configured to direct the plurality of modulated optical signals to the detector pixel.

8. The optical circuit of claim 1, wherein the source pixel includes at least one of a light-emitting diode (LED), an organic LED, a mini LED, a micro LED, and a vertical-cavity surface-emitting laser (VCSEL).

9. The optical circuit of claim 1, further comprising a spatial light modulator (SLM), wherein the SLM includes a liquid crystal display (LCD) panel comprising an array of pixels including the modulator pixel.

10. The optical circuit of claim 1, wherein the detector pixel includes a photodiode.

11. An optical circuit, comprising:
an M-by-N matrix of source pixels each configured to generate a plurality of input optical signals with a time interval, wherein M and N are natural numbers;
an M-by-N matrix of modulator pixels optically coupled to the matrix of source pixels, each of the modulator pixels configured to modulate the plurality of input optical signals with individual transmissivities or reflectivities to generate a plurality of modulated optical signals;
an M-by-N matrix of detector pixels optically coupled to the matrix of modulator pixels, each of the detector pixels configured to generate charges in response to the plurality of modulated optical signals from a corresponding one of the modulator pixels; and
a controller configured to electrically control an intensity of each of the plurality of input optical signals of each of the source pixels and the individual transmissivities or reflectivities of each of the modulator pixels to perform a multiplication-accumulation operation.

12. The optical circuit of claim 11, wherein the source pixels in a same row are configured to transmit identical input optical signals spaced by the time interval according to an array of input activations.

13. The optical circuit of claim 12, wherein the source pixels in a same row of the matrix of source pixels are electrically interconnected.

14. The optical circuit of claim 11, wherein the modulator pixels in a same column of the matrix of modulator pixels are configured by equal transmissivities or reflectivities spaced by the time interval according to a matrix of weights.

15. The optical circuit of claim 11, wherein the input optical signals in different rows of the source pixels are associated with different training sources.

16. The optical circuit of claim 11, further comprising a source substrate, a modulator substrate and a detector substrate parallel with each other, wherein the matrix of source pixels, the matrix of modulator pixels and the matrix of detector pixels are formed on the source substrate, the modulator substrate and the detector substrate, respectively.

17. A method of performing optical computing for an artificial intelligence accelerator, the method comprising:
generating K first input optical signals with a time interval by a first source pixel, K being a natural number;
directing the K first input optical signals to a first modulator pixel and thereby receiving K first modulated optical signals with the time interval, wherein the first modulator pixel is configured to be modulated, in correspondence with the K first input optical signals, according to K first weights;
receiving the K first modulated optical signals by a first detector pixel; and
accumulating charges of the first detector pixel by an integrator in response to the K first modulated optical signals to generate a result of a multiplication-accumulation operation.

18. The method of claim 17, further comprising synchronizing generation times of the K first input optical signals with K modulation times of the first modulator pixel.

19. The method of claim 18, further comprising a transmitting a clock signal to the first source pixel and the first modulator pixel to effect the synchronizing.

20. The method of claim 17, further comprising generating K second input optical signals with the time interval by a second source pixel, wherein the K first input optical signals and the K second input optical signals are generated based on a first training source and a second training source, respectively, and the first source pixel and the second source pixel are arranged on a same panel.
